(19) United States
(12) Patent Application Publication
(10) Pub. No.: US 2011/0261186 A1
(43) Pub. Date: Oct. 27, 2011

(54) Imaging and Archiving Method, System and Program

(76) Inventors: David A. Blackburn, San Diego, CA (US); Paul J. Kitchen, San Diego, CA (US); William R. Bradley, Las Vegas, NV (US); Bryan Madison, San Diego, CA (US); Christopher Robert Hetherly, Apple Valley, CA (US); Aaron Freeman, La Mesa, CA (US); William Clark Dale, San Diego, CA (US); Marlon B. Akins, San Diego, CA (US)

(21) Appl. No.: 13/177,422

(22) Filed: Jul. 6, 2011

Related U.S. Application Data
(63) Continuation-in-part of application No. 11/921,541, filed on Feb. 18, 2009.
(60) Provisional application No. 60/779,783, filed on Mar. 7, 2006.

(51) Int. Cl. H04N 7/18

(52) U.S. Cl. 348/92; 348/86; 348/E07.085

(57) ABSTRACT

A system, method and program adapted for collecting images of job-site conditions, plans and specifications. Images are annotated with attributes that relate to the location, time and trades involved and other aspects of the images. Job site images are collected with a camera connected to a portable data collection device. The portable data collection device is programmed with image attributes for a particular project. Images are also annotated with attributes gathered by sensors, such as GPS position data and direction information. Images with attached attributes are uploaded to a database server and indexed into a relational database. Images can be flagged and determined to be images for review which triggers automatic notification to the involved parties and follow up to confirm resolution. Authorized participants can access images in near real time, to make funding, insurance and other judgments about the project. Images are archived for safekeeping and long-term storage.

### CROSS REFERENCE TO RELATED APPLICATIONS

This is a continuation-in-part of U.S. patent application Ser. No. 11/921,541 filed on Dec. 3, 2007, which in turn is a national stage of PCT/US2007/005915 filed on Mar. 7, 2007, which in turn is an application claiming priority to U.S. Provisional Patent Application Ser. No. 60/779,783 filed on Mar. 7, 2006, the entireties of which are hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of construction and manufacturing review, and more specifically toward a system, method and program adapted for collecting images of job-site conditions, and plans and specifications. The images are annotated with attributes that relate to the location, time and trades involved and other aspects of the images. Job site images are collected with a camera connected to a portable data collection device. The data collection device is programmed with image attributes for a particular project. Images are also annotated with attributes gathered by sensors, such as GPS position data, moisture sensor information, and direction information. Images with attached attributes are uploaded to a database server and indexed into a relational database. Images can be flagged and determined to be Images for Review which triggers automatic notification to the involved parties and follow up to confirm resolution. Authorized participants can access images in near real time, to make funding, insurance and other judgments about the project. Images are archived for safekeeping and long-term storage.

In the past, construction projects were often managed primarily by the general contractor, either unsupervised or overseen by the architect or other independent expert for the owner.

More recently, construction management companies have been formed to oversee larger projects, including large commercial or residential buildings and large multi-unit projects. The motivation for using a construction management company is to improve the buyer's satisfaction with the end product, satisfy the requirements of construction defect insurers, and reduce the risk of and cost of construction defect litigation.

The construction management company is tasked with inspections of the job site to provide increased confidence that the project is being completed according to plan and with reduced defects. Photos may be taken of the project and manually annotated by the inspector. The primary product of the construction management company is reports that are generated as the project proceeds. The reports may include photographs and may be issued to include job costs, meeting minutes, change order requests, deficiency omissions (punch list), issue tracking and daily reports of job progress.

Despite the use of construction management companies, the costs of construction defect litigation continue to be a significant cost of the total project. Prior to this invention, no system existed that facilitates the generation of photographs by observers where the photographs are automatically linked to specific locations in the project, and which are updated frequently, in sufficient resolution to permit identification of defects by persons reviewing the photographs. Further, no system existed which provides a process for insuring that all of the defects, whether identified by the observer, or by subsequent review of the photographs, are tracked until they are reported resolved and photographically confirmed as resolved. Additionally, no system existed that allows photographic deconstruction of a location in a building to show whether or not the defect was created during, or post-construction. Also, no system existed which reduces the amount of demolition necessary to reach and correct a defect that surfaces after completion of a project.

Thus there has existed a long-felt need for a system, method and program that facilitates the generation of photographs by observers where the photographs are automatically linked to specific locations in a project. The need continues for such a system, method and program that enables tracking of defects until they are photographically confirmed as resolved as well as allows for photographic deconstruction of a particular location to show when, whether, and where a defect was created.

### SUMMARY OF THE INVENTION

The current invention provides just such a solution by having a system, method and program adapted for collecting images of job-site conditions, and plans and specifications. The images are annotated with attributes that relate to the location, time and trades involved and other aspects of the images. Job site images are collected with a camera connected to a portable data collection device. The data collection device is programmed with image attributes for a particular project. Images are also annotated with attributes gathered by sensors, such as GPS position data, moisture sensor information, and direction information. Images with attached attributes are uploaded to a database server and indexed into a relational database. Images can be flagged and determined to be Images for Review which triggers automatic notification to the involved parties and follow up to confirm resolution. Authorized participants can access images in near real time, to make funding, insurance and other judgments about the project. Images are archived for safekeeping and long-term storage.

The invention provides a method for gathering high-quality images on each unit or particular location in a project on a basis coordinated with a construction schedule. The images are taken by a person trained and licensed to use the system of the invention to ensure a degree of independent verification that the photographs will be representative of the actual and complete conditions as they exist on a periodic basis. The schedule is selected to provide sufficiently frequent inspections that the greatest majority of the defects will be caught by the observer and fixed before any deconstruction is required, and that where the defect repair requires demolition, that the subcontractor responsible can be identified before the repair is undertaken so that there can be no dispute as to the persons or companies responsible for the cost of repair.

In addition to photographic images at the job site, the invention provides for the scanning, uploading, and/or indexing of construction plans, computer-aided design (CAD) drawings, and other documents. These documents are indexed to the same location criteria as the photographic images such that when referring to a photographed location, the relevant portion of the plans can be viewed simultaneously so that it can readily be determined if the as-built photo confirms that the location is built to plan.

The system provides an automated process for dealing with defects that are revealed in images. This is referred to as the Images For Review (IFR) process, which is a process where information is conveyed to designated parties, including the general contractor and their superintendents, subcontractors and their superintendents who may be responsible, the developer, and virtually any and all parties to the contract. The oversight of the system is reserved to an organization with no financial stake in the project and no reason to be defensive about the fact that defects are created or that they may have not been properly repaired. This organization can be referred to as an Imaging and Archiving Company (IAC). The organization controls the hardware (such as servers), software, and access thereto that gathers and stores the images and associated data and generates the reports. This guarantees the integrity of the data. The integrity is such that owners, insurers and lenders can have a high degree of confidence that the necessity of costly site visits can be reduced, while still maintaining proper funds control, reducing the risk to the insurer and providing confidence of a quality project to the owner. The system produces a complete record of the construction of the unit/particular location up until the time of completion and even beyond. These records will be saved until the statute of limitations for the project expires or until the developer requests that they be destroyed. The ultimate buyer of the unit produced by the developer/manufacturer can purchase a separate valuable record of the construction history, which may be delivered on paper or on digital media.

The system has two basic sub-systems. The first is autonomous on-site information gathering, coding with attributes, and transmission. The second is the master system, which stores the collected and indexed data and communicates with the subscribers, including contractors, owners, subcontractors and others as permitted by the system. The on-site sub-system is designed to gather information on a periodic basis (e.g. daily) from a job site. The information is identified with a particular location, unit, floor, room, wall, direction, date and/or time as well as other information and criteria detected by sensors (e.g. moisture meter) or input by the observer. This sub-system has sufficient native intelligence to dramatically increase the probability that all the necessary information will be gathered. For example, the sub-system may be uploaded with the locations to be inspected, and requires that the observer confirm that the recorded location conform to that on the schedule. The observer is prompted to take scheduled images of specified locations and to attach selected attributes to images in addition to those automatically attached by the software. Continuing with the example, the observer can be required to note the prevailing weather conditions at the time the images were taken.

The most important information gathered by the on-site sub-system is high-resolution photographs. These photographs are loaded to the local sub-system, which may desirably be a tablet computer. Through the software on the tablet computer, information is stored on the job and on subcontractors so that the operator can identify the trades involved in a particular issue. Information is both automatically and manually entered to maximize the value of the image. For example, the software on the tablet computer automatically captures times, dates, locations, and trades. The observer can manually enter details of what aspects of the image should be further reviewed or that there is an apparent issue for resolution that will require review of the images (IFR) by all responsible parties. Additional sensors can optionally be employed; these include GPS position data with provision for remote antenna and recordation of the unit offset from the antenna, infrared moisture detectors, altimeters, and magnetic compasses for direction recording. Once the information is validated by the computer program residing in the tablet computer, it can be uploaded to the server. This can be real time wired or wireless transmission, or via wired or wireless connection to the servers at the end of the day or some other time. The information gathered is attached to the images and the images are then uploaded to the server. This can be on a real time or near real time basis so that the server always has current information. The information is uploaded as soon as possible so that the participants can have confidence that all relevant information is available on-line. The server database software uses the attributes attached to the images to perform basic indexing on the images entered into the database.

The camera sensor is desirably a single lens reflex (SLR) multi-mega pixel, high-resolution unit. The selection of the SLR format is one of the steps taken to assure that the images reveal all of the information that the observer sees in person. Using the camera in conjunction with a tablet computer permits a large number of photographs to be taken, stored, and uploaded. Using a high-megapixel, high-resolution, digital camera permits subsequent zooming in for details as small as a single protruding nail. The efficiency with which the images are gathered and indexed permits a large number of images to be collected, which increases the assurance that all necessary features will be duly rerecorded. For example, it is typical to gather hundreds or even thousands of photos for each single-family home being inspected.

The server acts as a secure archive of information so that the permitted users can have a high degree of confidence in the integrity and accuracy of the information. The information has immediate value to entities such as the construction lender as an aid in funds control. The lender can view more information in greater detail than even a typical on-site inspection would reveal, ensuring that funds are not advanced until the entire project reaches the agreed milestones. The archiving aspect of the system ensures that all of the gathered images will be available long into the future for legal defense, contractor evaluations and similar purposes. The system tracks IFRs, including how quickly the issue was reported, resolved, and instances where an issue, reported as resolved, in fact required multiple “Go Backs” before the issue was indeed fixed. This allows the responsible parties to be charged for the costs associated with additional inspections and the increased job costs caused by the delay. For example, if the delay prevents another trade from working on the unit and this pushes the contactor an additional day into the penalty phase of the contract, the cost of the penalty can be passed on to the subcontractor. The system also tracks the observer to ensure that all scheduled inspections are timely made.

Although the system can be controlled by the owner, architect, construction management company, or general contractor, the maximum benefit of the system is obtained where the persons gathering the on-site information are specifically trained in identifying defects and confirming corrections. Where these persons are provided by a construction management firm, the firm will receive training and will be licensed to use the system. If the construction management firm fails to properly inspect and repair, they can be replaced, even in the middle of a project, in part because the new construction management firm will have a complete photographic record of the project progress up to the date of their coming on the job. As an alternative, the construction imaging and archiving company can provide observers, so that the individuals and their employers have no financial stake in the cost of construction, defect remediation or subsequent dispute resolution. In either case, the information gathered is tracked in a system maintained by a wholly independent imaging and archiving company (IAC), who maintains the on-site systems (software and hardware) and the servers where the information is stored and from which the information is communicated. The server also tracks the observers to be sure that they visit locations at the right time and that they identify a high percentage of the defects visually, so that few defects are left to be detected by review of the images.

An important operating tenant of the system and method described herein is that the best way to reduce the costs of construction defects is to identify defects early, make sure the defects are corrected and maintain evidence which documents that process and result. A secondary consideration is that the system allows a photographic step-by-step record of the construction process so that if a defect (such as a leak) shows up in the finished construction, that the area under inquiry can be photographically deconstructed to reveal the exact location of the most likely place for the defect. This reduces the amount of demolition necessary to locate and fix the defect.

Images, and the associated observations, are scheduled to coordinate with the construction schedule. For example, the system will extract data from the construction management program and determine that dry wall will be installed in a particular unit on a particular date. Prior to the installation of the drywall, the observer will photograph the stud wall, wiring, plumbing, ducting and the like prior to those features being covered up. If any defects are noted, they will be communicated by the system to all of the necessary parties and construction management will be advised to hold up the dry wall installation until the issue is resolved. A meeting involving at least the contractor and subcontractors involved will be automatically set. Notes reflecting the outcome of the meeting will be made available on-line. This is another example of how the system puts the resolutions of the problem as a first priority without concern for the fact that the meeting notes themselves could be used in evidence. This system is designed to be transparent to all of the authorized persons during the project and anticipates that all of the information may become available to all parties if there is a later dispute. The knowledge by the participants of this possibility aids in the integrity of the information gathered, and the resolutions that are documented. When an IFR is communicated to the appropriate persons, a hold on further work at that site is issued and maintained until the observer's images confirm that the issue has been resolved.

It is a characteristic of the method that senior construction experienced personnel will make the observations. The automation of the image gathering and the automatic distribution of IFRs make the process sufficiently efficient that senior people can be used without undue costs.

As a project nears completion, a video is made of the final inspection, which records such details as running hot and cold water, scoping all drains to confirm that they will be free running, and testing of all electrical outlets. The correction of each item on the punch list is also photographically documented. This provides evidence to the unit owner, for example, that a particular drain was working at completion, so that the owner should take responsibility for any subsequent blockage. This process improves the quality and consumer satisfaction, and helps reduce the cost of post-completion repairs in addition to documenting those facts for a possible legal defense.

It should be understood that a subset of the features described above can be employed at the discretion of the responsible parties. For example, the imaging and archiving firm may be contracted to merely gather images and not oversee repair and compliance. The feature of the invention that is basic to all levels of support is the feature of gathering, uploading, indexing and providing controlled access to images and associated data. At a minimum, the images must be identified and indexed by a unique unit ID, the location within the unit being photographed, and the date/time of the image.

Construction defect litigation presently adds an average of $23,000 per unit on all multifamily residential projects of 20 units or more. Construction defect litigation will be greatly reduced and the cost of resolving the remaining disputes is minimized when it can be demonstrated by a third party that the construction was performed correctly in the first place.

Most wrap insurance policies currently have a clause that allows for as much as a 20% discount when the developer uses approved risk management methods such as those described herein to mitigate construction defect litigation. Rather than the traditional reactive approach to risk management, services provided by the current invention provide a proactive model, mitigating the threat of litigation while also preventing developers from having to meet separate deductibles for each and every occurrence, and preventing most occurrences altogether. Because the current system and method substantially lowers the cost of construction, builders, developers, wrap insurance companies, and other involved parties using the system will be able to gain a competitive advantage by offering a higher quality product at a lower price to their consumers. Litigation often punishes the most-visible, best-funded target because the cost exposure is so great that the litigation often settles more on the cost of going forward, rather than the culpability of the specific defendants.

Overall, the system encourages all parties on the project to employ good practices because they are aware that their work is being photographed and viewed by many people. After the project is complete, the superior level of quality, communication, and accountability demonstrated within the images and the participant's logged correspondence will be archived and stand ready to defend against the threat of litigation without destructive testing. The availability of this information will reduce the cost of settlement.

When a client or technician using the current invention notices a problem, they are able to send the image along with any necessary explanation to the responsible party. The issue is then tracked until completion and schedule impacts are assessed.

By allowing jobsite conditions to be viewed and communicated by clients and their specified participants, the number of people viewing a job increases substantially, which increases the probability of finding and fixing all defects. The current invention's methods reduce the risk of construction defect issues that are often left unnoticed, uncorrected, or are covered up. Issues left undetected almost always lead to construction defect litigation. Even those defects that are subsequently discovered without litigation end up costing the developer substantially more than it would have cost to do the job correctly the first time.

It is an object of the invention to provide a system and method that reduces construction defect litigation.

It is another object of the invention to provide a system and method for reviewing and following issues in construction.

It is a further object of this invention to provide a system and method for archiving data and generating reports construction projects.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a flow chart showing the path from taking the image to distribution to users (participants).

FIG. 2 shows sample screen shots of the project setup process.

FIG. 3 shows screen shots of the upload information process.

FIG. 4 shows the flow path for project set up.

FIG. 5 shows the user assignment process.

FIG. 6 shows the entire data path from images of locations or documents to the ultimate access by approved users (participants).

FIG. 7a shows the attributes attached to an image.

FIG. 7b shows the way the image is indexed in the image list.

FIG. 8 shows an exemplary entry in the expanded image list with all of the applicable attributes checked.

FIG. 9 shows a screen shot of a data entry page where the information on images for review (IFR) is collected.

FIG. 10 is a flow diagram that shows how an IFR can be created after review of uploaded images, or during on-site image capture, and how the IFR is flagged, entered, and tracked to resolution.

FIG. 11 is a flow diagram showing the process for scanning in plans and construction schedules and generating the gathering of on-site images to correspond to particular phases of the construction scheduled.

FIG. 12 shows the features of the project list screen, which summarizes and provides access to images and IFRs.

FIG. 13 is a screen shot of the image list with thumbnails of the images collected.

FIG. 14 is a screen shot of the filtering options for displaying selected images on the images list.

FIG. 15 is a series of screen shots showing how an image is added to the IFR list, categorized and sent to the selected recipients.

FIG. 16 is a screen shot that shows the first step in the set-up of a new project.

FIG. 17 shows screen shots of how location values are created and edited.

FIG. 18 shows screen shots of how location values are created and edited.

FIG. 19 is a series of screen shots showing how selected photos can be edited and annotated. This function will only be available to the master administrator on the project and will be tracked by the IAC to ensure that information integrity remains intact.

FIG. 20 is a series of screen shots which show how an administrator can add users and assign levels of access depending on the user's need and level of authorization.

FIG. 21 shows a flow chart of the processes within the portable data collection device showing how attributes of an image are selected and attached to an image.

FIG. 22 shows the project edit function.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

The preferred form for practice of the invention is to employ an imaging and archiving company to oversee the gathering, archiving and distribution of information on the progress of construction and the resolution of potential defects. The use of an independent company dramatically increases communication among the parties and in turn improves the quality of construction and mitigates exposure to construction defect litigation. The IAC captures photographic and video images throughout the entire process of a construction project. There is no motivation for the IAC to hide defects or to delay their resolution.

The images, or links thereto, are stored in a relational database that is accessible through secure internet connections. Password-protected accounts are issued to the various parties that have subscribed, and their access to the images and associated data is defined by their level of subscription, contribution to the project itself and the value of their contractual obligation to the project as a whole. These steps guarantee the integrity of the information, which increases the confidence of the insurance carriers and lenders while leading contractors and subcontractors to make better long-term decisions because the information will document the party at fault, even years after the project is complete.

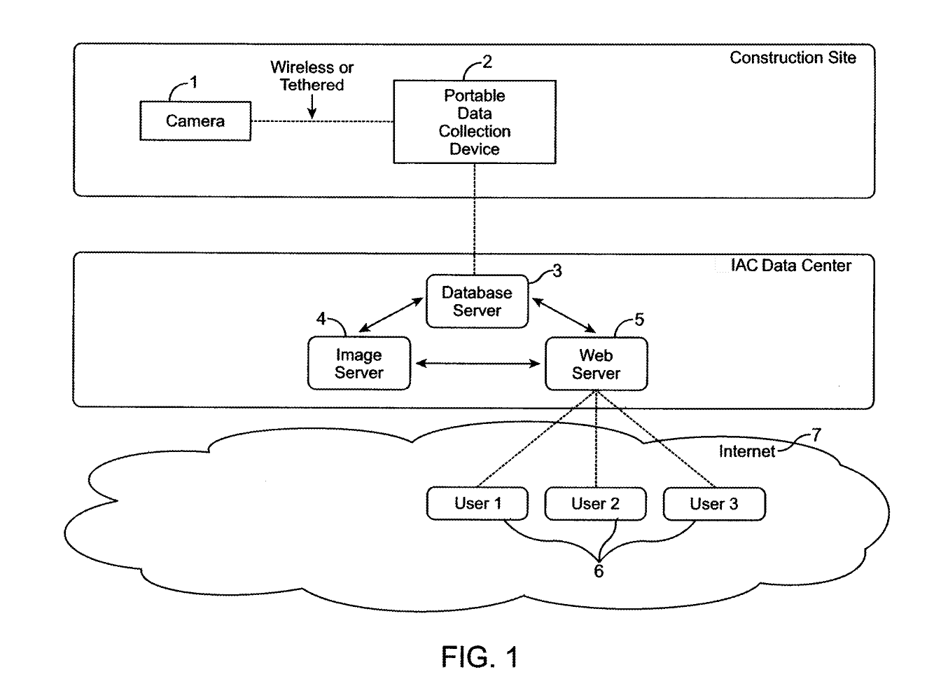

The basic information flow is illustrated in FIG. 1. A digital camera 1 is shown connected to a portable data collection device (PDCD) 2. This device may desirably be a tablet computer because generous amounts of storage are available and the ability to make entries with a stylus is well-suited to the work environment. Nonetheless, other types of portable computers may be used just as well. The PDCD is programmed with parameters of the particular job to facilitate data entry and provide confirmation that the location and other parameters are correct. The collected data is uploaded to the system's servers. As illustrated, the servers include a database server 3, image server 4 and web server 5. The data may be uploaded wirelessly in real time or when the PDCD is returned to a facility with upload capability. In either event, the PDCD retains the data until its storage on the servers is confirmed. Much of the indexing of the data is done on the PDCD so only minimal manipulation of the data is necessary before it is ready for distribution to the participants. The servers include an image server 4 that archives all of the images and their associated data for use by the system in generating reports. The image server may be updated by a local computer (not shown). This would be the entry point for images of constructions plans that are scanned in using a large format scanner and indexed with location, trades and other data that can be retrieved at the same time as photographic images of that same location and stage of construction.

The PDCD obtains parameters of one or more particular jobs. These parameters, also known as a task list, are downloaded to the PDCD from the server of the current system. In a preferred embodiment, the parameters of one or more particular jobs are downloaded to the PDCD at the beginning of each workday, thereby enabling a technician to appropriately plan out the order in which he or she plans on completing the image capture and/or review of each particular job.

One or more servers may be used to store the data discussed herein and provide restricted access thereto. The data, or attributes, may be stored in various manners, including in a database and/or as separate files. For example, the images may be stored as individual files, with the file paths of each specific image and associated attributes and parameters stored in the relational database. This allows for fast and efficient indexing and access to the images and associated attributes without unnecessarily large databases.

The PDCD may store the images and associated data in a manner similar to that of the server. After an image is captured by a digital camera and transferred to the PDCD, software located on the PDCD can read in exchangeable image file format (EXIF) data created by the digital camera and stored in the image file, such as in the Joint Photographer Expert Group (JPEG) format. This data can include a coordinated universal time (UTC) stamp, latitude, longitude, magnet direction, altitude, vertical orientation, and camera settings. This data, along with parameters of the particular job and additional data entered by the technician, is saved in a local database residing on the PDCD. The image is stored separately, with a link to the image stored in the local database.

As stated above, the data located on the PCDC is transferred in real time, near real time, or at a later time to the IAC's server(s). In a preferred embodiment, the databases between the PCDC and the server are synced, where the images are separately transferred at the same time. The databases may be synced in a variety of manners, including using SQL statements/commands and/or proprietary software. As will be appreciated, the location of the images as they are stored on the server, or some other data allowing unique access to individual images, is also saved in the database on the server to allow access to the aforementioned images and associated data. However, as will be appreciated by those skilled in the art, the images may be stored directly in the database.

Alternatively, all the data associated with a particular image is saved as EXIF data thereto. In this manner, when the image is uploaded, all relevant data is also uploaded. The server reads in the EXIF data of each image, and stores that data into a relational database. The image is then preferably stored separately, with a link to the location of the image stored in the database.

When the information is uploaded, it is made available to participants/users 6 through the web server. Any authorized participant with access to a computer on the Internet 7 can check on up-to-date job progress, IFRs, participate in meetings and receive other timely communications.

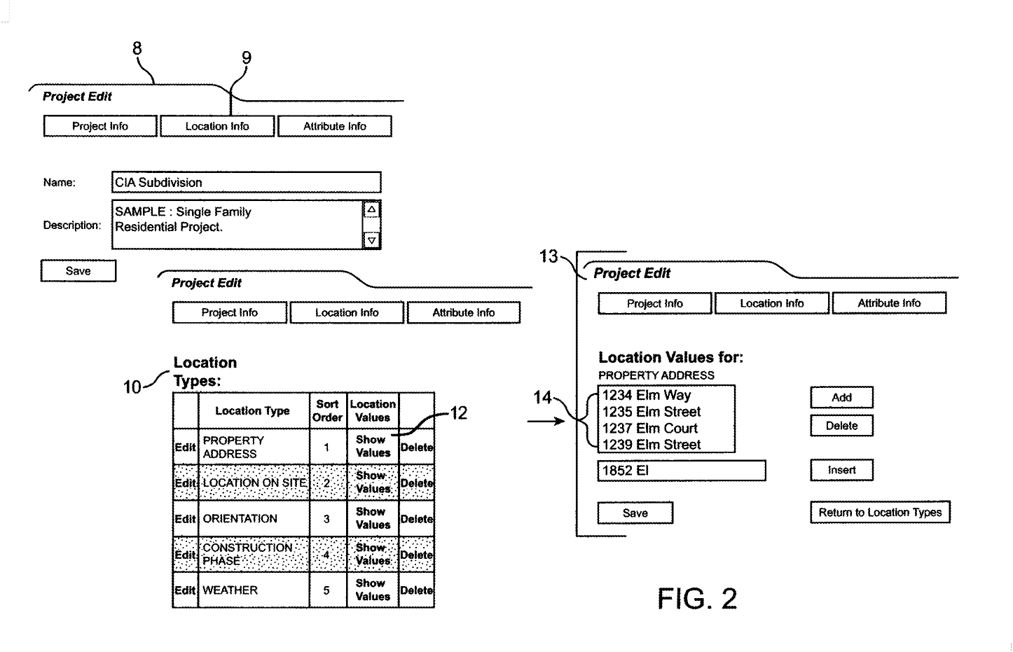

FIG. 2 shows the process for setting up a new project into the servers. The project plans and specifications are evaluated and those points in the construction project when on-site images should be taken are established. A technician then adds specific project data, or attributes, in the project edit screen 8, including project, location and image attribute information. FIG. 2 shows the progress of the location information from selection of the location info link 9, the location types screen 10 which includes information that will become image attributes, including address, location (e.g. unit number, floor, room), the orientation of the camera when taking the image (e.g. facing the north wall). All location types, values, and attributes are customizable. In the figure, the address “show values” link 12 has been activated which produces the screen 13, allowing the technician to add property addresses or select from those already entered at the property address screen 14.

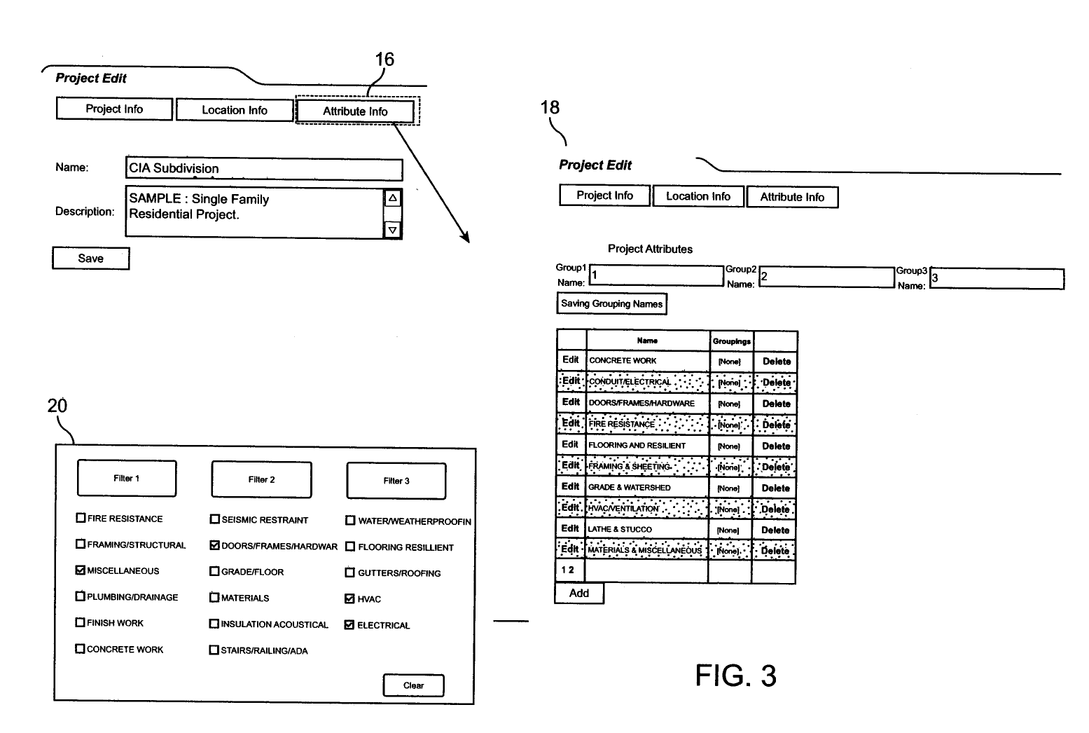

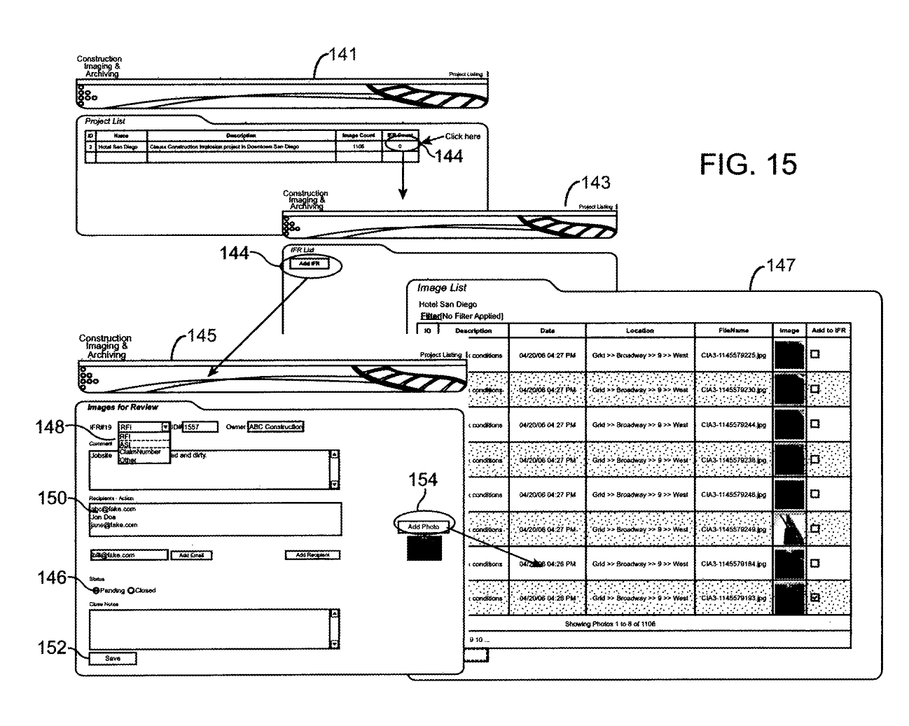

FIG. 3 shows the continuation of the project edit function in the entry and editing of the attributes with which the taken images will be tagged to facilitate their later indexing and from which reports and IFRs can be generated. When the Attribute Info link 16 is activated, the technician can assign attributes in screen 18 that will be important to the observer during the project. For example, concrete, electrical, and HVAC are shown in screen 18. The technician has the ability to assign attributes to a group. When the technician is in the field, these will show up as links on the PDCD that can be selected with a single click, and which then generates all of the attributes to be checked for a construction feature that commonly has those attributes. The links have similar characteristics to those in the search function within the website (See FIG. 15). For example, a stud wall would have HVAC, doors, electrical and other attributes and these may be selected as a group in screen 20.

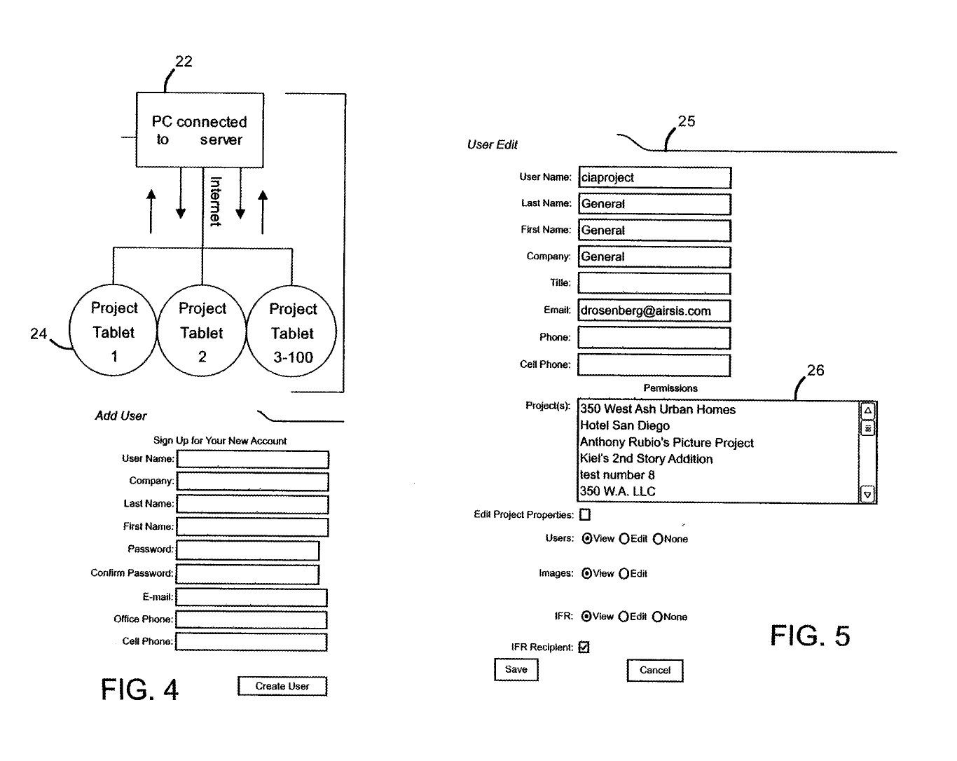

FIG. 4 shows the user/participant assignment process. A personal computer (PC) 22 connected to the server is used to enter the project attributes and schedules, which then programs tablet computer 24. The tablet computers can be remotely programmed over the Internet. The initial programming includes scheduling of images, information on trades/subcontractors, locations, and default image attributes. As the project progresses, data from the field, including that uploaded from the tablet computers, is used to revise the scheduling to reflect actual conditions. The tablet computers can be updated via the internet to reflect these changes, so that only the most current scheduling information is used to determine when a site visit is made.

FIG. 5 shows the user assignment process. Users are given levels of access selected from their need-to-know information, the value in having them review the information and the security and privacy of the information. The entry screen 25 allows a user to enter basic identification, contact and security (password) information. Then a technician assigns varying levels of access. For example, a plumber may be restricted to viewing information and images about plumbing. Screen 26 shows assignment of a user to multiple projects and a selection of whether the user is to receive IFRs.

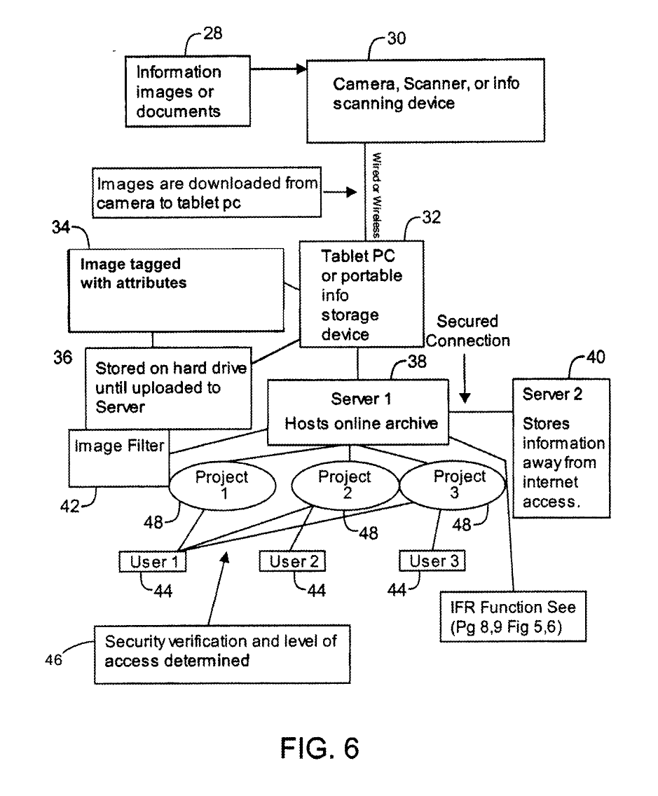

FIG. 6 shows the image capture and distribution process. Documents, information or photos 28 are acquired and imaged by a camera or scanner at 30. For example, a camera is used to take an image of a location, that image is transferred to a tablet computer 32, the image on the tablet computer is tagged with attributes 34 including those automatically generated by the camera or other sensors (e.g. direction), those attributes programmed into the tablet computer (such as trades) and those added by the observer (such as apparent defects). The images taken by the camera are stored in the tablet computer's memory (normally a hard drive), until successful upload to the server 38 via a secure Internet connection or by taking the tablet computer 32 to a location where an authorized computer is in wired connection to the server. The uploaded images may be run through an image filter 42. This image filter 42 may act on all or a select subset of the images for enhancement and/or correction. The server 38 may be a single machine or the three separate machines described earlier for database, image and web communications. In fact, any number of physical servers may be used in practice, as is appreciated by those skilled in the art, to support the required functionality of the system. A second server 40 is shown for storage. This server cannot be accessed over the Internet and thus is secure from hacks and other threats. It can be used to restore projects which may have been corrupted for any reason. Images on the server can be filtered to drill down to the photos of specific interest. Users 44 can access the server, subject to security verification 46 and have access to those projects 48 for which they have been granted access.

The system of FIG. 6 is used by the observer taking the photos to attach attributes, problems, notes and may flag an image for review (IFR).

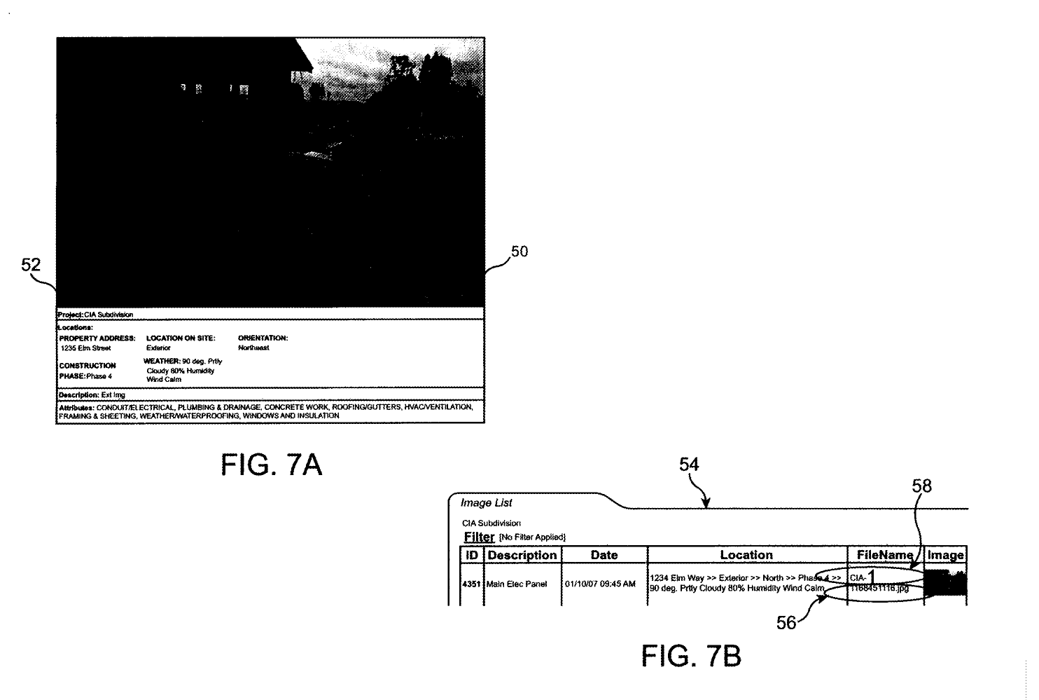

FIG. 7a shows a typical image 50, taken by an observer and shows how all of the on-site image attributes 52 are attached. In this case, the attributes include a large number of construction trade related features that can be observed in the image, including plumbing, roofing HVAC, sheeting, windows and insulation. This image will automatically be available to authorized participants. For example, it would show up in a search by an authorized plumber, and would show up in a search by the developer (who has access to all images) when the developer filters the search to look at plumbing-related images. The location is itemized down to the address, aspect (exterior) and direction. The phase of the project and ambient weather conditions are also noted.

The process requires the use of an on-site image technician who may also be an inspector or consultant, but in the exemplary embodiment is described solely in the role of an observer. Generally, the technician will be an employee of the IAC who will have no financial stake in the cost of completion of the project. The photographic images are captured through a range of possible formats, including high-resolution stills, video, infrared and camera snakes. The images are automatically coded with attributes that are used to identify specific characteristics of the photograph. These attributes may be altered depending upon the type of project. The attributes can identify dates, locations, trades, and specific issues as they occur. These photographs are then uploaded to the server where users can view, sort, filter, organize, send, and print the images to resolve construction issues or facilitate remote project management, inspections or for meetings and discussions. Having an observer on-site greatly reduces the occurrence of ignored and hidden problems that are passed on as the responsibility of someone other than the truly responsible party.

In FIG. 7B, it is shown how an image is indexed in the server. The image list 54 summarizes the image with date and location and assigns a unique image ID 56 which desirably is the time in seconds to four (4) or more decimal places, from a start point together with the ID 58 of the tablet computer which first stored the image.

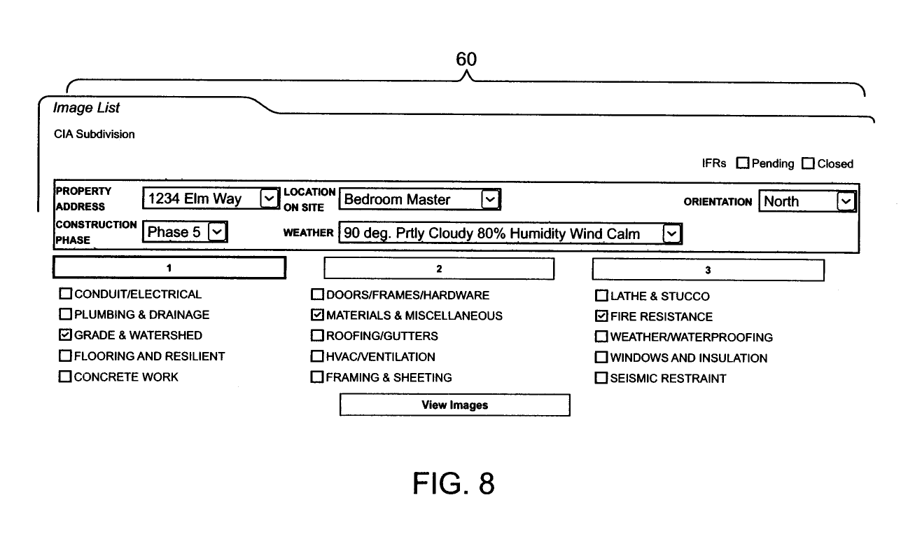

FIG. 8 shows a screen shot of how images in the image list can be filtered to show only images of interest to the participant. The screen 60 allows selection of location, phase, direction, ambient conditions, and one or more trade related categories and whether or not there is an IFR.

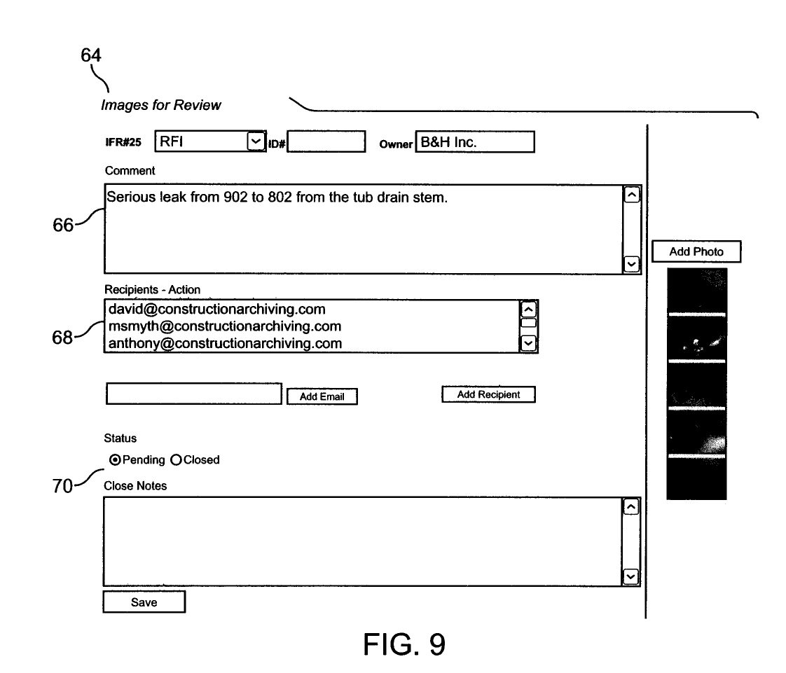

FIG. 9 shows the Images for Review (IFR) set up screen 64. A list of emails 68 is included so that all the necessary recipients can be designated. A field 66 to describe the issue is provided. When an image is tagged for review, a time line is initiated and tracks the time to resolution when the item is closed at 70. Thumbnails of the attached photos are shown and can be selected for full-screen high-resolution review.

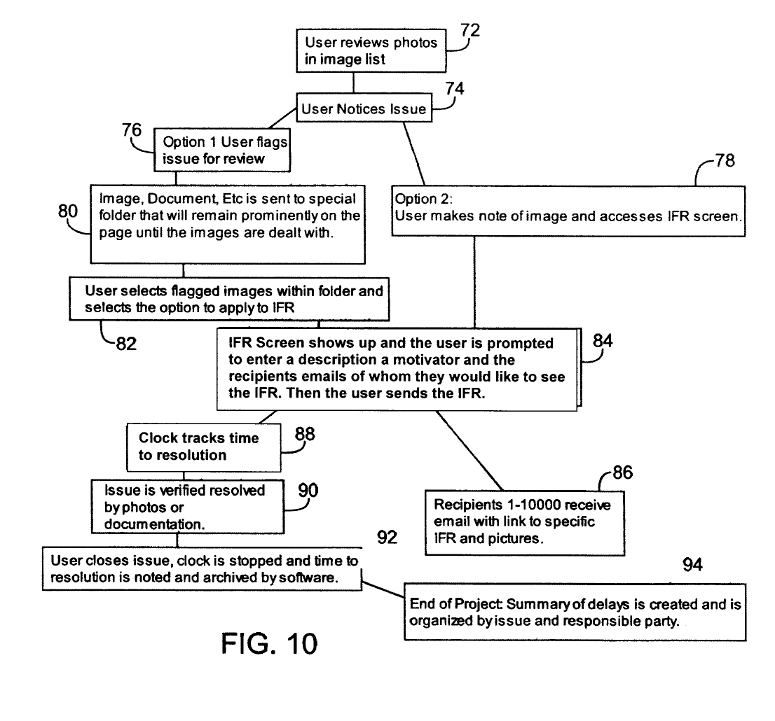

FIG. 10 shows the IFR process when the IFR is identified by review of the images. A user reviews the photos in the image list 72. The user notices an issue at 74. At that stage, the user can elect to directly establish the IFR by accessing the IFR screen at 78, or can flag the issue for review at 76. The flagged issue is associated with the document and/or image and sent to a special folder 80. The inquiry is drawn to the attention of other users by the flagged status. After consideration of the information, if the issue is determined to be an IFR, the flagged issue is selected at 82 and the user is sent to the IFR screen 84 to set up the IFR. Once set up, the IFR is emailed to all the selected participants at 86. When the IFR is established, a time line is initiated at 88. When the issue is reported as resolved, subsequent images are reviewed at 90 to confirm that a fix has been made, which closes the time line at 92. The time for resolution is retained and summarized at 94 so that the total delays caused by each party can be determined at project end.

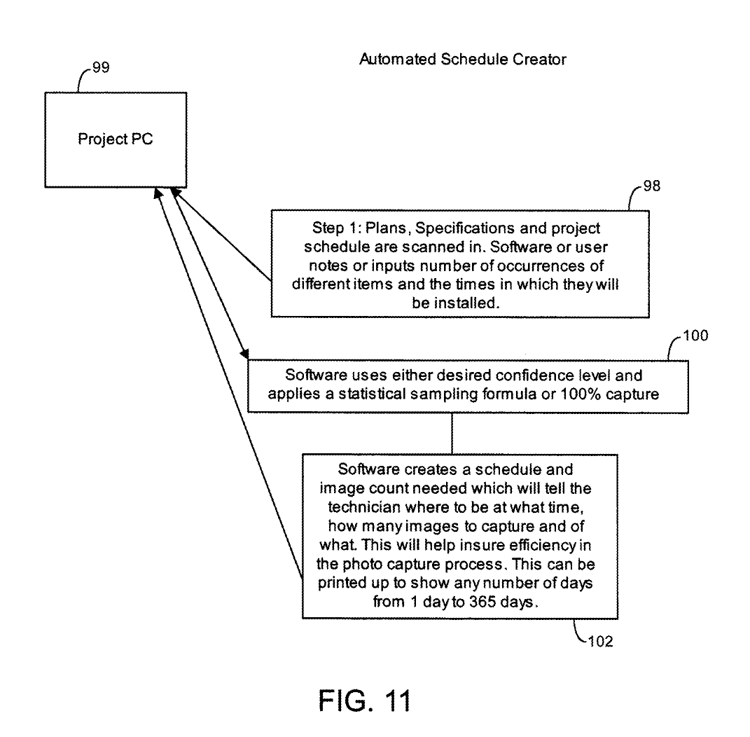

FIG. 11 illustrates the use of a project personal computer (PC) 99. The project computer 99 is the entry point for all data not uploaded wirelessly from the tablet computer. It is used to initiate a project. The first step 98 is to upload data such as project plans and specifications, which may be on paper and are scanned in, or data from other software (such as schedules from construction scheduling software). The project computer is also used to apply the selected confidence level at 100, which generates a formula for use in maximizing the relevance of a reduced number of images, or to elect one-hundred percent (100%) capture, which produces images of every significant phase of construction. At 102, the software uses any sampling formula established at step 100 and creates an on-site imaging schedule, which will eventually be uploaded to the tablet computer. The results of the project computer initiation of a project are then uploaded to the servers.

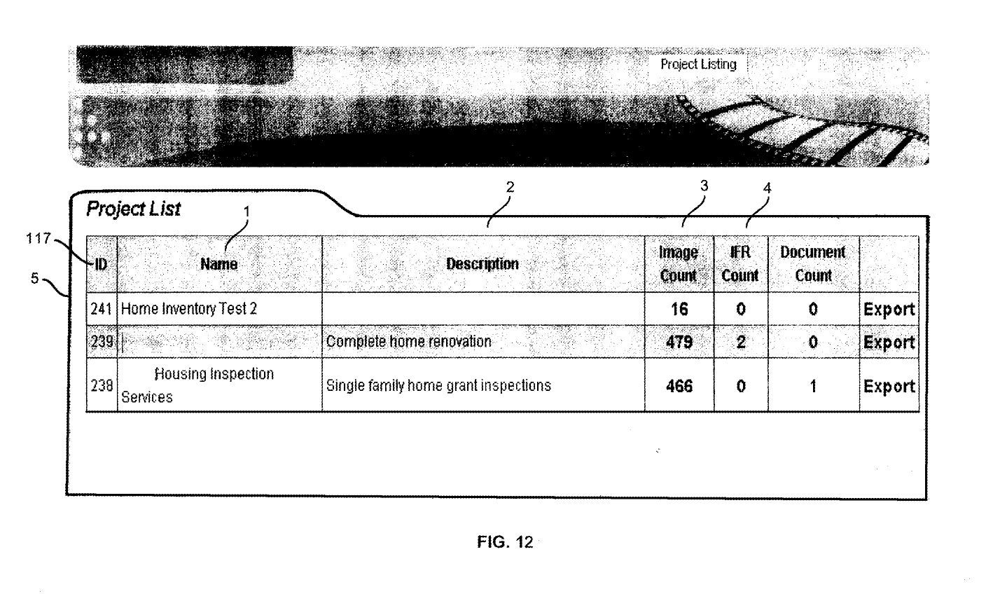

FIG. 12 is a screen shot 116 that shows the summary information available in the project list. Included are the project ID 117, the project name 118, the description of the project 120, the number of images generated at 122 and the number of IFRs generated at 124. The images count 122 represents the number of images taken of the project. Photos can be viewed by clicking on this number. The IFR count 124 tallies the number of IFRs identified. The IFRs can be viewed, edited and created by clicking on the number under IFR count.

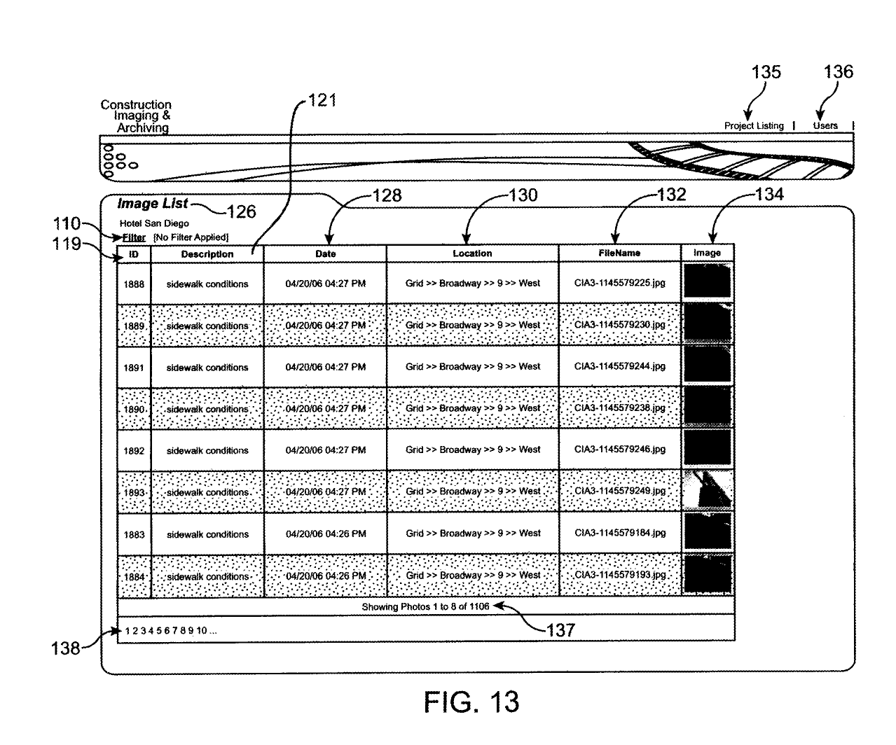

FIG. 13 is a screen shot of the image list 126. The data about the images is listed in columns and includes the image ID 119, the description 121, the date the images were taken 128, the location 130, and the camera ID, which precedes each filename at 132. Thumbnail images 134 are useful to show the nature of the image captured and clicking on the thumbnail takes the user to a larger version of the image. Clicking on the project listing 135 takes you to that screen. Clicking on users 136 allows the administrator to assign additional users and to establish access and security levels for those users. The display at 137 shows the range of photos displayed on the page, while the links at 138 allow the user to navigate to different screens, full of photos. A filter link 110 accesses the filters, described in FIG. 15 below.

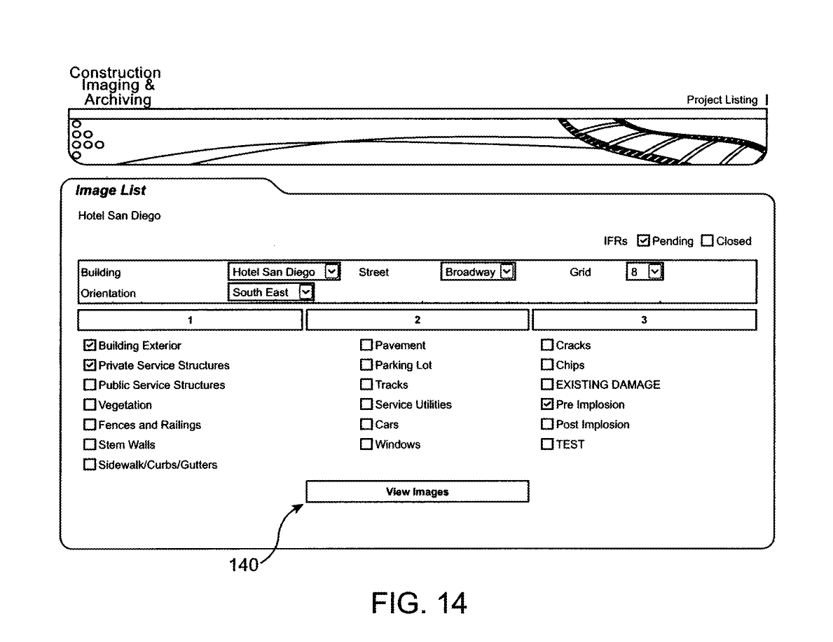

FIG. 14 demonstrates the use of filters to directly access all images of particular interest to the user. Filters are used to search photos by the different attributes/identities that were assigned to them. Any of the items in the menu can be checked to filter the photos by specified criteria. For the listed project, the images were captured to document the demolition by implosion of a large building, to show surrounding structures and features before and after the implosion. Therefore the filter might be used as is shown to select a group of images with pending IFRs associated with the exterior of the building and orientation selected and of private service structures visible before the implosion. Once the desired boxes are checked, the view images link 140 may be selected and the user will be presented with all of the images that meet the filter criteria.

FIG. 15 is a series of linked screen shots showing how IFRs are selected from the project list by selecting the link embedded with the number of IFRs. The user views a project list in screen 141. The user views an IFR list screen 143 by selecting the number of IFRs 142, in this instance there are zero (0). Initially, since there are no IFRs already identified, the user is given the option of adding a new IFR by selecting the link 144. That selection brings up a screen 145 where the characteristics of the IFR, including its status at 146, are entered. A pull-down menu 148 allows identification of the motivation for creating the IFR including RFI (Request for Information), and ASI (Architectural Supplement of Information). Email addresses can be entered for all the participants who will be notified of the IFR and/or searched within the project directory. The project directory is a list of all of the parties involved in the project and their contact information. Users can click on the names of the desired recipients 150 and their email addresses will automatically be entered as a recipient of the IFR. The Add Photo link 154 allows photos from the image list to be added to the IFR, as can be seen in screen 147, which can subsequently be reviewed by clicking on the thumbnail. When the Save link 152 is selected, all selected participants will immediately be notified.

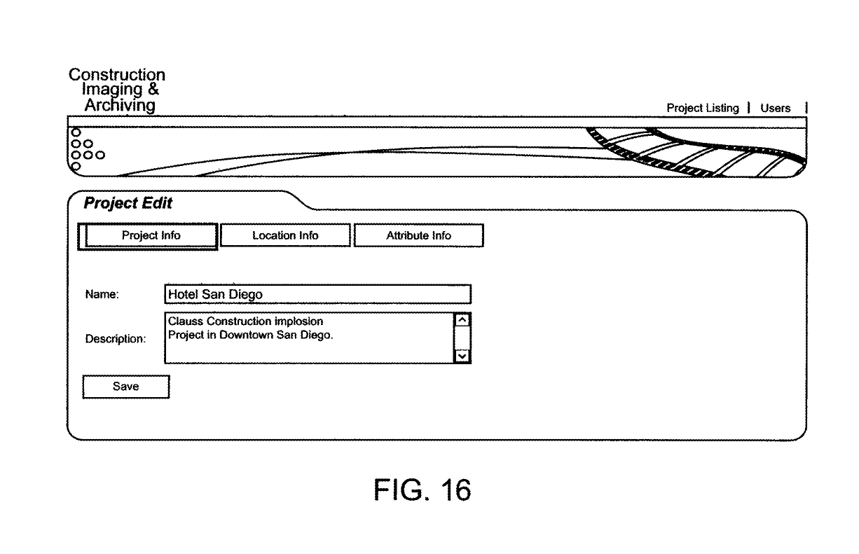

FIG. 16 shows the opening screen for the Project Edit function.

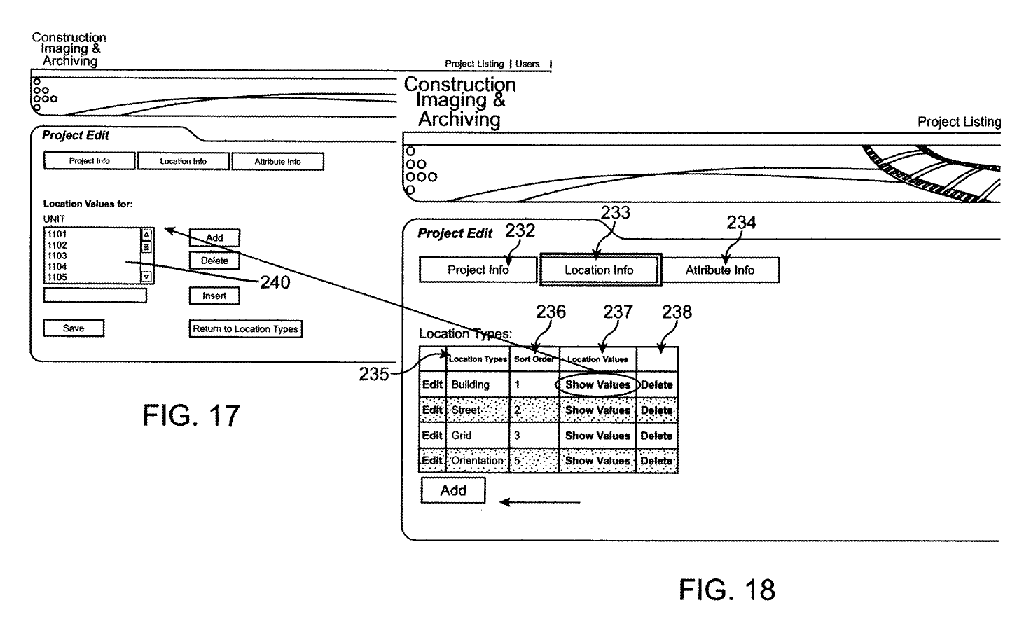

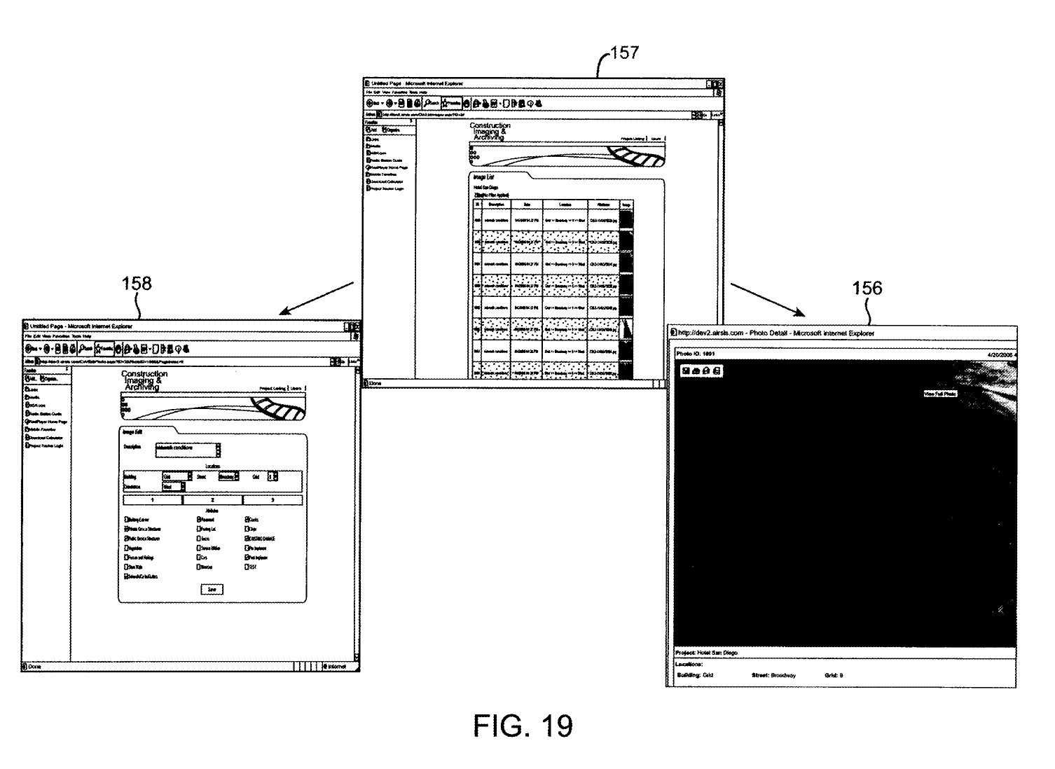

FIG. 18 represents a continuation of the initiation process. At the project edit screen, the location of images to be taken can be edited from that generated automatically and additional image locations established. For example, for a particular building in a project, location information is selected, and from the resulting display the building information can be selected. When the “Show Values” link in the location values column 237 is selected, the screen in FIG. 17 is generated, which shows the unit numbers and allows for the addition or deletion of units from that list.

The entry point for the location name is shown in FIG. 17. Location 232 identifies the link to the project information screen. Location 233 directs users to the location page. Location 234 directs users to the attribute page. Location 235 identifies location type. Location 236 selects the order that data appears in the tablet computer application.

Location 237 sets location values to add the different items that would fall under the location type. An example would be a location type called “unit” and the location values could be the unit numbers such as 1101, 1102, 1103, etc. FIG. 16 is a screen shot of the screen that opens when a location value in column 237 is selected.

FIG. 17 provides the facility-to-location values, such as the unit numbers 240 in the illustrated embodiment.

The delete function 238 allows the user to delete the location type. When location type is deleted, so are the location values that may have been assigned to that location type.

FIG. 19 shows a series of three linked screen shots associated with the photo edit function. A large version of photo 156 from the image list 157 (see FIG. 15) can be displayed. Then the edit screen 158 is displayed by clicking on the photo ID (see the file name link in FIG. 15). In the edit screen, the photo's attributes can be changed to reflect what is represented in the image. Note, however, that the photos are preferably annotated first at the job site by the technician.

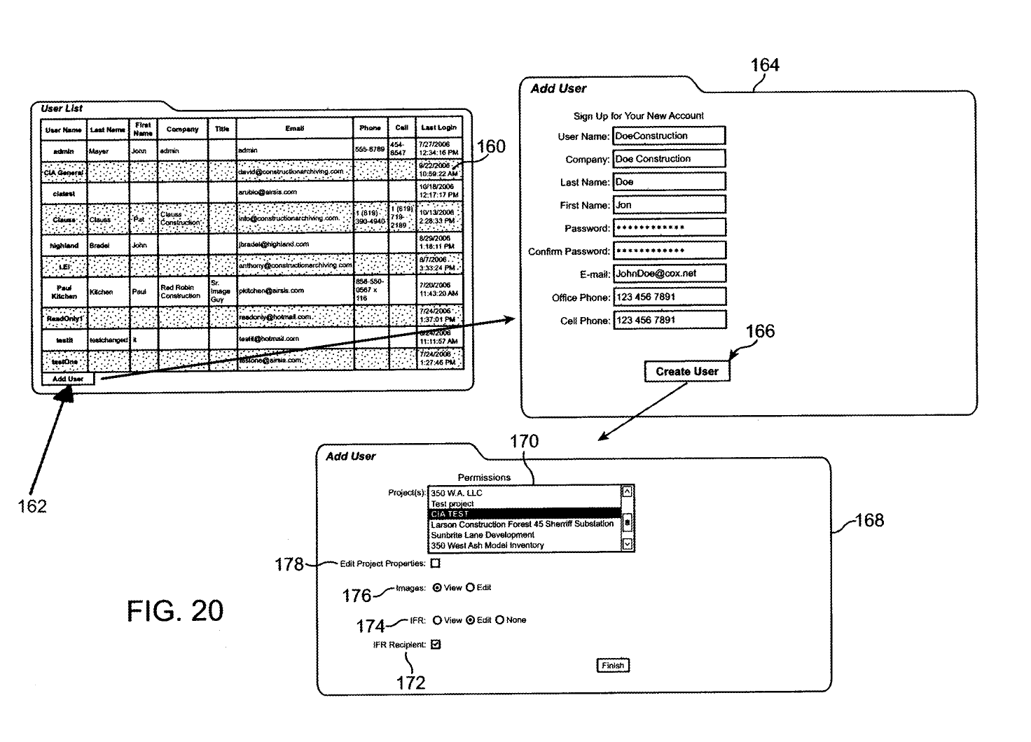

FIG. 20 shows the Assign Users function. This function may be accessed by selecting the user link (such as in FIG. 18), which produces the display 160 where existing users and their contact information are listed. New users are added by selecting the Add User link 162, which opens screen 164 where user names and passwords are assigned. When the Create User link 166 is selected, the permissions screen 168 is displayed. Permissions are specific to the selected project 170 on the menu and identify the user as someone who does or does not receive IFRs at 172 and whether those IFRs can merely be viewed or edited at 174. Similar choices are made for images at 176 and for the project at 178.

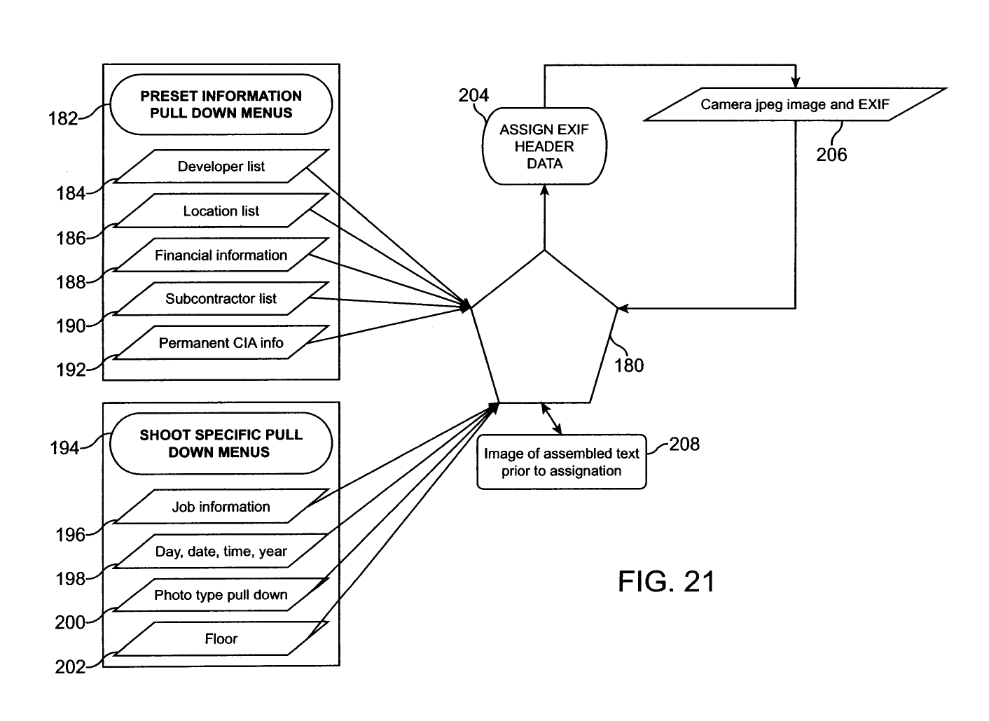

FIG. 21 shows the information maintained on the servers 180 that is accessible by pull down menus. The preset pull down menus 182 access the information that is predefined and ready to be used in a new project. It includes a list of developers 184, location list 186, financial information 188, subcontractor list 190 and permanent information on IAC 192. The shoot specific menus 194 contain menus for set up on image gathering and indexing. The information about the job or project 196, date and time 198, photo type 200 and floor number 202 are included. The system assigns header data 204 to the images so that the photos on the servers 180 are permanently tagged with identifying information, including EXIF data generated by the camera 206. Images of plans and text 208 are also scanned to the server 180.

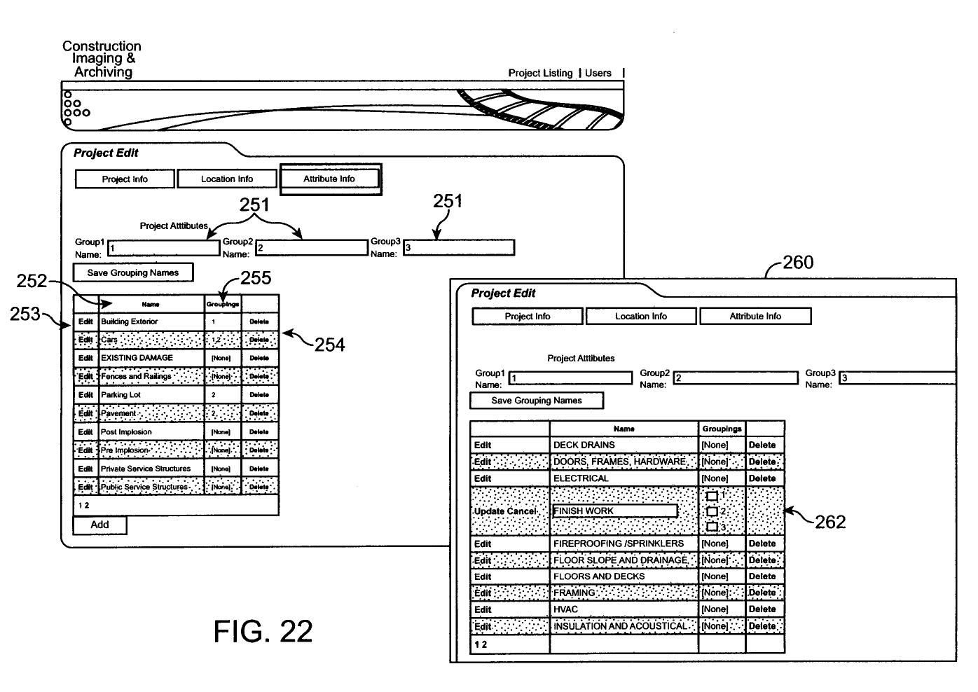

FIG. 22 is a screen shot of the project edit function. Three group names 251 are provided. This button allows the user to name the groupings. Groupings allow the user to group certain attributes together in order to allow the image technician to click the group names and have pre-selected patterns of attributes automatically checked to save data entry time. Column 252 contains the name of the attribute. The delete column 254 permits the attribute to be deleted. In the Groupings column 255, group attributes for various features of the project (e.g. building exterior) are displayed. Selecting the edit column 253 opens screen 260. The user can add the numbers of one or more of the groups one, two, or three at location 262, to add all of the attributes of the select groups to the feature (in this case, Finish Work).

Having described the various screens and information flow in the interconnected computers (server, tablet, and project computers), the processes facilitated by the software are described below.

### Information Storage

While the CIA technician is onsite recording information through the software, the information will be temporarily stored in the memory of a local device (which in the exemplary embodiment is a tablet computer) and/or will be uploaded in real time to the server(s) via a wireless internet connection. Even where the normal mode is to upload wirelessly in real time, when there is not an adequate wireless connection on the jobsite, information is always stored, if only as a precaution, to protect the day's work on the tablet computer. Therefore, the technician can return the tablet to an IAC-controlled location where the images that were stored on the hard drive during onsite information recording can be uploaded to the servers and then backed up to another server which is not accessible by users via the internet. Every time the images are uploaded, they are erased from the tablet computer's hard drive to insure that all but a very small amount of locally stored information is in a protected format and location. Such a protected format can include commonly known and tested encryption techniques. The servers, which host the online archive, are duplicated in a collocation facility capable of safe-guarding the information against intruders and natural disasters. Additionally, to ensure the information's integrity, the IAC should periodically audit project files to insure that the files remain in the same condition throughout the period in which IAC is contracted to store them.

### Information Capture and Sorting

A senior project engineer is appointed to track each project and assigned a back up. The engineer will have taken extensive training from the IAC. This engineer will have passed a rigorous testing process and have worked in the construction field with many years of verified experience. As a result, that person will have a wealth of information about construction, especially the type of construction being performed on the subject project. As a result of this experience, they can spot potential trouble that would be missed by less trained persons. Both the construction management company and the engineer are licensed by the IAC and continue to be licensed only so long as they maintain the integrity of the system. The engineer will be an employee of the construction management company performing the work. The firm itself will have been selected after careful analysis and only after it meets specific criteria established by the IAC. Each technician will wear highly visible and distinctive clothing so that their presence and purpose on the jobsite will be known to all those present onsite. This technician will be capturing images on a daily basis or other specified interval. At a minimum, the IAC will provide images taken on a weekly basis and, immediately before each inspection, on every unit on the entire project from beginning to the end. The image capture will be scheduled at specific times as work is completed and as inspections are made. This will be evident when looking at the photo schedule, which is a copy of the project schedule (generated by Microsoft Project or whatever scheduling software is utilized by the general contractor). If the images are not marked as taken on the “image capture schedule,” the software will notify the IAC office.

Utilizing a specialized portable data collection device, such as a programmed tablet computer connected to a camera, is preferable. Each image is coded with attributes such as floor, unit number, direction, trade and specific pertinent issues. The attributes that are not automatically applied to the image by preprogramming in the tablet computer are applied by the technician on site. The software prompts for missing attributes, such as weather conditions. The images are sent to the computer, automatically sorted and uploaded at the IAC's server, or secured archive site. This allows the developer, construction lender, funds control firm, general contractor, subcontractors and insurance carrier (or any other subscriber who is part of the project), access to images, in many cases as they are taken and as the work is archived. Since the images are high resolution they can be examined with a zoom function to inspect, for example, single protruding nails, to determine if they will be a source of future problems. An image may be tagged as an image for review (IFR) either by the observer as the images are taken, or by subsequent review of the images by any of the participants given the authority to initiate IFRs.

The technician attends all of the scheduled meetings. That is, both the superintendent construction meetings with the subcontractors, and the owner meetings with the general contractor. Meeting minutes are copied and sent to the server for the appropriate parties to review from the beginning. Contractually, the IAC will also have the right to attend any meetings the subcontractors hold to help them resolve issues that have been identified.

The pictures, software, hardware and all proprietary information will remain the property of the IAC. This ensures that the software on the tablet computer is always up-to-date and that no one can tamper with the integrity of the image gathering process.

Images are captured by the technician under two different scenarios and the way the images are handled varies accordingly.

### Scheduled Construction Images

These images are captured on a predetermined time scale based upon the actual construction schedule for the project. The technician will know what, where, when and how to capture these images before the shoot takes place in any one location. In an alternative embodiment of the invention, the computer system will be input within the location and subject of the images to be captured, but then the system asks the technician to verify that the information is correct and will not allow images to be stored unless the two locations and details match. An electronic triangulation device in operable communication with the software confirms each location.

### Construction Specifications and Drawings

The IAC maintains a large format scanner to input plans and specifications. In the case of plans, the technician will normally employ a network connected computer to code the plans and specifications with attributes that correspond to those collected with the on-site images. The attributes include the locations, relevant trades and other information necessary to retrieve the specification and plan images that correspond to a selected image.

### Images-For-Review (IFR)

The IAC offers three levels of service. The first level is the most basic and offers the least third-party protection and evaluation of a project. With the first level of service, an IAC technician will be sent on the site strictly as a third-party observer and will not make any recommendations or point out anything that may be an issue to clients. The first level offers an extra set of eyes and the opportunity for clients to view their project's conditions from anywhere in the world. Clients at this level can communicate and track the resolution of issues that the client identifies from the photos. The photos are available on the client's online archive, and the client can flag and attach images to messages they send to any party involved in the project. The method of communicating issues is called the Image for Review (IFR) function.

The second level of service will also include the ability to initiate IFRs, but also includes IAC technicians flagging images that may represent an issue. The technician will not make any recommendations or specifically identify the nature of a potential issue, but will note that there may be something of importance within the photos they flag for client review. With the second level of service, it is still the client's responsibility to determine if the photo shows a viable issue, and to orchestrate the next steps for resolution.

The third and highest level of service will incorporate all of the features of levels one and two; however; IAC technicians will also take a proactive role in the quality control of the project. With the third level of service, IAC's technicians will initiate IFRs and propose fixes to issues that they may encounter while onsite. The IFRs may be attached to any of the methods of communicating issues within a construction project such as a Request for Information or an Architectural Supplement of Information, but they also can stand alone as a newer, more efficient and more organized way of communicating jobsite issues. When these IFRs are initiated, a timer is started which tracks the time from issuance of the IFR to resolution of the IFR. Outstanding IFRs remain in a very prominent location in the online project archive to insure that they are not forgotten, and clients can print out lists of the IFRs for follow-up, such as at project meetings. IAC technicians at this level of service are looking out for things that are “Red Flag” issues. Specifically, the technicians are trained to notice conditions that are visually different from supposedly identical conditions occurring elsewhere on the site. In the past, these issue differences have often been associated with minor problems, but occasionally they identify major construction problems that have had large associated dollar values.

IFRs force subcontractors and even general contractors to stop trying to avoid responsibility for a defect and spend their time instead on working to resolve the problem. A significant part of the value of this is attributed to the way that the current system and method handles these IFRs.

The process of the IFR system is:

1. The client and/or technician notices something amiss and captures and/or flags an image of the issue and adds a simple annotation.

2. The software generates an email from the annotated image that is automatically sent to the specific subcontractors, general contractor, job superintendents and the developer.

3. The image is “flagged” and shows up prominently on the system's website as an IFR and is held in the IFR file.

4. The software then marks the email “REPEAT MESSAGE” and resends it to the same mailing list at preset intervals, such as daily at 9:00 AM.

5. The repeat message will continue to be resent until the issue is resolved and the original IFR is “un-flagged” and relocated in a “RESOLVED ISSUES” file.

6. The technician is then notified to “GO BACK” to the location of the issue and capture an image of the resolved issue for confirmation that the issue has indeed been resolved.

7. Though a certain number of “GO BACKs” are included in any IAC package, once the pre-agreed number of “GO BACKs” has been reached, any additional “GO BACK” work will cause additional billing from the IAC. Since the parties involved are obvious, so will be the payment responsibility for the additional bill.

By generating a report that shows what the issues were, who was responsible, how long it took them to react and the quality of the subsequent remedial work, the system has the effect of making people more accountable for their work and for the work of their employees. The reports clearly identify consistent problems and problematic contractors who can be watched carefully or replaced if required. Since the data on the reports is cumulative, it shows trends and brings focus to repetitions of issues by location, by time period, by trade or by subcontractor. This process gives everyone who is given access to view the performance record of each and every party working on the project. It also gives the IAC the ability to rate everyone working on the project for use by subsequent developers, contractors, lenders, insurance agencies and others working within the construction industry.

The IFR Report is automatically sent to the developer, general contractor and the owner of the sub-contracting company. This report will help contractors avoid negligence in performing their contractual duties and clearly identifies gross negligence for insurance purposes. Thus, the report has value to the owner, developer and insurance carrier.

### Construction Web Site

The current system incorporates a relational database that houses all of the images, files and documents for all of the IAC's projects. Access to the data will be via encrypted access web browsers that require positive authentication and discriminatory password clearance. Images and other data are transferred for storage in the database in as close to real time as possible. The coding of the images is mostly done at the time the image is taken or scanned so that minimal additional processing of images is required. As soon as images are in place, they can be viewed by all authorized participants. The images are accessible to the developer, lender, fund control firm or insurance company by using their discreet password. Each subscribing subcontractor will have access to their trade activity images. All contractors have access to IFRs during the project.

In a preferred embodiment, the images of one or more projects are organized geographically and accessed by selecting one or more portions of a map. To achieve this, a user views a map through a web browser. This map may be two-dimensional or three-dimensional and optionally include satellite images. By selecting specific locations on the map, preferably marked with an icon, users can pull up information related to that location. This information can include images, IFRs, and other relevant data.

For example, a developer may have a housing development project under review by an IAC. Images are tagged by their longitude, latitude, and preferably altitude. With this data, the images and associated IFR data can be overlaid on a map. To review the status of a particular location, the developer accesses a secure website. The website displays a map of the housing development, with icons over locations where images and/or IFRs are available for review. For multi-story dwellings, the altitude, if accurate enough, may be used to further narrow down which unit the developer wishes to view. By clicking on one of the icons, the developer may view the images taken at that location and/or review relevant information regarding that particular unit or house.

All participants have access to the construction schedule and the schedule of images to be taken and to the completion of the images as they are tracked and shown on the schedule.

### Finished Product

At the end of the project, binders are assembled for principal locations such as each floor in a unit as well as for the common areas and other important locations such as utility, mechanical and fire control rooms, stairwells and the like. These binders are provided to the clients. In each binder is a floor plan of the area concerned, marked with the location of each image taken. The images may be grouped by any of the following criteria: Unit number, room, date, construction trade, inspection or event. A slide show from the images captured can be displayed to reproduce the entire construction process, the work of a particular trade or the progress of a unit.

### Finished Product for Unit Owners

When buyers close escrow, each owner can purchase a binder and/or disk containing the images of their unit during its construction. The disk may include a video of the walk-through inspection of the unit showing the technician testing the following: electrical outlets, the water (hot and cold) being run, all drains, including tubs, showers, sinks, toilets, washers, dish washers and deck drains being scoped to prove that they are clear at the time of the test.

### Tracking Procedures

A central IAC office has technicians tracking each project across the United States on each construction web site. They look at current and verified schedules to confirm that pictures are matching the schedule. They will also look for signs of schedules that are slipping, constantly being adjusted and/or unrealistic. If the schedule is not being maintained, IAC notifies the owner or developer. All contractors and subcontractors will have a clear understanding of this protocol and will be expecting it, so that voluntary compliance is enhanced.

The owner, developer, banker, construction lender, fund control agent, construction management office and others can watch the web site for pictures to see that the work matches the schedule. IAC technicians log in daily to every project. Every time they log in, the date, time and duration of the visit is tracked for IAC clients to note. If any of the IAC field technicians are not performing, IAC will know almost immediately because the software notifies IAC of any failure to meet the image schedule. In the event of poor performance by the site technician, the technician is contacted, the situation assessed and explanations noted, or the technician will be replaced with a new technician from the same firm. If the second technician has problems performing, the licensed firm (normally a construction management company) will be replaced, their IAC license suspended and access codes cancelled. The IAC central office has substitute technicians capable of taking over any project within 24 hours of notification. The central IAC office can control all the draws for licensed construction management companies that employ the licensed field technicians. This makes it impossible for the construction management company to take draws that don't accurately represent the actual progress of the project.

### Licensing Criteria for Construction Management Firms

The first choice for companies to be licensed under the IAC program are pre-qualified construction management firms across the United States that have the expertise to provide first-rate IAC services. As these firms are selected to service a project within their immediate area, they are licensed, trained and registered to perform IAC services. The criteria for an acceptable firm include that they must meet the financial qualifications established by IAC, have an unblemished legal reputation, have adequate qualified staff, provide a substantial performance bond on each project and agree to a legally binding licensing contract with IAC. The license is revocable at any time if the qualities of the services that are being provided are not up to the IAC's written standards. Non-performance will cause the construction management firm to loose their license with IAC.

### Licensing Criteria for Others Including Developers, Owners, and Lenders

All participants that use IAC services will sign contracts that acknowledge that all the hardware, software, processing, documents, photographs, reports, methods, practices, information and the like are temporary use.

### Advantages and Benefits

1. On-site professional, licensed, experienced technician tracking the project daily, studying the plans, taking pictures and watching the schedule.

2. IAC technicians will be visible to all workers on the site by wearing a fluorescent yellow shirt with the Imaging and Archiving Company name printed on the front and back. This lets everyone know that their work is being documented and motivates them to perform to the highest standards.

3. The IAC technician is tracked as to when he logs in and out and for how long he spends reviewing the site, schedule, and quality of pictures taken.

4. Real time pictures posted as they are taken or on the same day.

5. Real time notification of problems.

6. Real time of notification of resolutions.

7. Tracking and timing the number of days to resolve issues.

8. Identifying subcontractors slow to resolve issues and tracking the number of issues that each subcontractor creates or that are discovered by the IAC engineer.

9. Notification of all issues electronically with attached pictures and written comment to all appropriate contractors, owners, developers, bankers, etc.

10. On-site video which helps prevent theft, vandalism and waste.

11. As many as tens of thousands of pictures can be taken to facilitate directing accountability to every trade on-site.

12. Quality control is enhanced merely by the IAC technician's presence on-site, which all parties and workers know can be established by review of the pictures taken at the site visit.

13. Remote tracking of the project at most any location with internet access.

14. Significant reduction of inferior work by an IAC presence.

15. Discovery of defective work and correction as it may be occurring.

16. Specific close-out protocol on each and every unit.

17. Pictorial verification that all systems are operational in each unit.

18. Scanned documentation from subcontractors performing and verifying functionality of all systems within each unit, common area, and within the entire building.

19. Verification that all drains are clear, plumbing works, electrical outlets work, HVAC is operational, windows don't leak, and gutters are functional.

20. Backup redundant systems by the IAC office to track schedule, quality construction and archiving for the period of the applicable statute of limitations or longer as directed by the developer.

21. Backup and technician replacement capabilities in place with 24-hour notice by the construction management firm as well as the IAC corporate office.

22. Capability to review and deconstruct photographically any wall at any unit, common area or room in the entire building (this makes destructive testing a thing of the past).

23. Capability to enhance the photographs to identify the most minute details (such as slip track screws heads to confirm that they were loose prior to the installation of the drywall).

24. Access to real time construction photographs for the fund controller, which will allow him or her to see and verify “percentage complete” without ever leaving his or her desk.

25. Reduced exposure to construction defect litigation.

26. Accountability for damage, defect and delays directly to the responsible contractor.

27. Protected, stored and maintained archiving for, a minimum of ten years on every project.

28. Binders for every floor including a compact disc (CD) with lists of pictures on each wall of every unit through the entire project, sortable by dates, trades, subs, floor plans and easily understandable graphic instructions and directions to navigate the IAC system of photographs.

29. Possibility of binders for each unit owner with a CD of the entire construction process with video of all inspections to verify that all of the drains are clear of any obstructions as well as close out protocol on each unit.

30. Last, but not least, is the fact that all of this information is made available to hundreds of sets of eyes. This, of course, may result in further enhancement to the quality of the project as well as further limit possible exposure to future construction defect litigation issues.

This method of sharing information through the system's software enhances communication among all of the related interests in a construction project.

### Due Diligence

Due diligence is defined as the process of thoroughly and accurately investigating any and all possible outcomes given specific criteria, expectations, variables, opportunities and conditions. The process that has been put in place by the current invention ensures due diligence with the specialized software, personnel training and redundant systems that protect the owner, developer, insurance company, lender and others against construction defect litigation.

### Additional Services

Additional services are available for punch and closeout of the entire project. The system will document the completion of the punch list of every unit and will photographically track the completion of the punch list for every unit. IAC will track the time to complete the punch list while tracking the specific contractors that are to provide the work on repairs. It will communicate with the general contractor and owner regarding all the contractors that have issues with the final punch list. This will permit the owner/developer, banker, funds control agent and general contractor from releasing the final retention on any contractor who has outstanding issues. It will also be incentive for the contractors to finish their punch lists at the earliest possible date. IAC will notify all subcontractors of their responsibilities via the same system that is in place with IAC during the construction of the project. IAC will track the re-inspections of each unit and notify all parties when the punch list completion is accepted at every location. IAC will track the inspections and re-inspections for the entire project including but not limited to the units, all common areas all utility, electrical, cable, security, fire control, janitorial or other rooms in the building. IAC will make the contractor accountable for the total completion of every location in the project. When a developer has photographs of these events and inspections, the developer can hold all parties to the highest standards. The developer can also control the release of the retention on the entire job. To legally retain this control until the very last detail is complete is a powerful and effective tool. This also allows the developer time to assess any liquidated damages that the developer may be entitled to as against the general contractor or any specific subcontractors should they have fallen behind on the schedule or out of sequence.

Where the IAC provides these services, many finish issues and mistakes are identified, as well as many warranty issues that often develop within the first twelve months of the project. During punch list completion, IAC is on-site long enough to identify many inferior finish issues such as door drops, ceiling finishes, defective tape joints, wood floors that show poor connections, failed appliances and building systems, leaks in HVAC units, damage by contractors to common areas, including elevators, halls, lobbies and more. The fact that IAC is overseeing completion of all of the punch list items allows it to assist in the correction of these issues. This includes general conditions, overhead and profit, and site management. The presence of the IAC shows every homeowner, manager, prospective owner and marketing personnel that the developer is serious about providing a quality product.

The IAC has the ability to access and provide evidence to assist with legal issues such as liquidated damages, negligence, fraud, contract violations, schedule problems, inferior hardware, product alteration and substitution.

While the above embodiments have been described with respect to a real estate construction project for multi-unit dwellings, the same system and method can be used in other industries as well without departing from the scope of the current invention. For example, the imaging and archiving system and method described herein can be used for the manufacture of aircraft, marine vessels, single unit homes, and infrastructure construction and maintenance. In this manner, the technicians are experts in the respective field to which they are reviewing and imaging. For example, if a particular job involves imaging and reviewing aircraft engines, the technician should be an individual with experience in building and/or repairing aircraft engines.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A method of documenting a manufacturing project comprising the steps of:
entering project data on a server, where the project data includes location and image information, where the server is accessible via the Internet;
transmitting the project data, or a portion thereof, from the server to a portable data collection device;
capturing one or more images of a particular part of the manufacturing project;
adding and associating attributes to the one or more images;
transmitting the one or more images and associated attributes to the server;
saving the images and associated attributes on the server, where the attributes are stored in a database;
making the one or more images and associated attributes available via restricted access over the Internet.

2. The method of claim 1, wherein the manufacturing project is the construction of multi-unit dwellings.

3. The method of claim 1, wherein the manufacturing project is the construction or repair of a marine vessel.

4. The method of claim 1, wherein the manufacturing project is the construction or repair of an aircraft.

5. The method of claim 1, wherein the attributes are provided by the project data transmitted to the portable data collection device.

6. The method of claim 1, wherein the attributes are provided by a user of the portable data collection device.

7. The method of claim 1, wherein the attributes are provided by a camera, where the camera captures the one or more images.

8. The method of claim 1, further comprising the step of:
identifying an image for review, wherein the image indicates that an issue must be resolved.

9. The method of claim 8, further comprising the step of:
capturing one or more additional images showing that the issue indicated in the identified image for review has been resolved,
transmitting the one or more additional images to the server.

10. The method of claim 1, further comprising the step of:
indexing the attributes in the database thereby providing fast and efficient access thereto.

11. The method of claim 1, further comprising the step of:
archiving the database and images, where the archive is saved to a separate server.

12. The method of claim 1, wherein the server comprises a plurality of physical server computers.

13. The method of claim 1, wherein the attributes comprise latitude, longitude, UTC stamp, magnetic direction.

14. A method of documenting the progress of a construction project and tracking the correction of defects prior to project completion, comprising the steps of:
sending a trained technician to the construction site on a schedule coordinated with the actual progress of construction and with a pre-programmed portable data collection device for storing images and image attributes,
observing the progress of construction at specified locations in the project,
taking images of the specified locations and attaching pre-programmed and technician provided attributes to the image including date, time, and location information,
providing for flagging an image, immediately after it is taken or any period thereafter, as revealing a possible defect requiring further review,
uploading the images and attributes from the portable data collection device to a networked computer,
indexing the image by attributes into relational database software,
providing controlled access to the images and attributes including access to images flagged as requiring further review.

15. The method of claim 14, wherein images flagged as requiring further review are automatically sent via electronic mail to parties responsible for correction of the defect and for oversight of the correction process.

16. The method of claim 14, further comprising the steps of:
scanning images for construction plans and specifications for a project,
assigning attributes to the scanned images to include a location of and trades affected by the particular scanned image,
indexing the plans and specifications by attributes into said relational database software.

17. The method of claim 14, wherein controlled access is provided via web browser.

18. A method of documenting a manufacturing project comprising the steps of:
entering project data on a server, where the project data includes location and image information, where the server is accessible via the Internet;
transmitting the project data, or a portion thereof, from the server to a portable data collection device;
capturing one or more images of a particular part of the manufacturing project;
adding and associating attributes to the one or more images;
transmitting the one or more images and associated attributes to the server;
saving the images and associated attributes on the server, where the attributes are stored in a database;
making the one or more images and associated attributes available via restricted access over the Internet;
identifying an image for review, wherein the image indicates that an issue must be resolved;
capturing one or more additional images showing that the issue indicated in the identified image for review has been resolved; and
transmitting the one or more additional images to the server.

19. The method of claim 18, wherein the attributes comprise latitude, longitude, UTC stamp, magnetic direction, and location.

20. The method of claim 19, wherein the location attribute comprises an address, unit, and room.
